(19) United States
(12) Patent Application Publication
(10) Pub. No.: US 2002/0154889 A1
(43) Pub. Date: Oct. 24, 2002

(54) Video pre-processing/post-processing method for processing video efficiently and pre-processing/post-processing apparatus using the same

(75) Inventors: Jong-gu Jeon, Suwon-si (KR); Yong-je Kim, Suwon-si (KR); Sang-ug Kang, Anyang-si (KR); Jung-wook Suh, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD

(21) Appl. No.: 10/125,549

(22) Filed: Apr. 19, 2002

(30) Foreign Application Priority Data
Apr. 19, 2001 (KR) 2001-21122

(51) Int. Cl. H04N 5/76; H04N 5/225

(52) U.S. Cl. 386/46; 348/714; 386/117

(57) ABSTRACT

A video pre-processing/post-processing apparatus which stably operates at high speed with a minimum memory using a new hardware-software cooperation method, and a method used by the apparatus. The video pre-processing method for capturing video includes assigning numbers to a plurality of memory regions in order and circularly increasing the numbers in response to a frame synchronizing signal, checking the storing memory regions in response to the frame synchronizing signal and capturing input video data, and storing the captured video data in the memory regions in a predetermined order. The video post-processing method includes assigning numbers to a plurality of memory regions in order and circularly increasing the numbers in response to a frame synchronizing signal, displaying the memory regions in response to a video synchronizing signal, checking the displayed memory regions, and storing video data in the memory regions in a predetermined order, and sequentially displaying the video data stored in the memory region.

### BACKGROUND OF THE INVENTION

1. Field of the Invention

The present invention relates to a video pre-processing/post-processing apparatus, and more particularly, to a video pre-processing/post-processing apparatus which is capable of stably operating at a high speed with a small amount of memory using a new hardware-software cooperation method, and a method used by the apparatus. The present application is based on Korean Application No. 2001-21122, filed Apr. 19, 2001, which is incorporated herein by reference.

2. Description of the Related Art

In general, video data input to a camera are stored in a memory in response to a capture command for encoding the video data. Since a display device processes a maximum 30 frames per second, it takes a minimum of 33 milliseconds (ms) to process one frame. Thus, a hardware unit generates a vertical synchronizing (Vsync) signal for indicating the possibility of capture every 33 ms, and a software unit causes the sending of a capture command and a memory address to the hardware unit whenever the Vsync is generated. Subsequently, the hardware unit stores the video data captured in response to the capture command in the memory.

Also, video data that are decoded by a decoder which operates through software are stored in a predetermined region of a memory and displayed on a display device such as a liquid crystal display (LCD). Whenever the memory is updated, the software unit causes the sending of updated information and regions of the updated memory to the display device. In this way, two or more memories are usually used to store the video data during encoding and decoding processes, and the memory is referred to as a ping-pong memory.

At this time, in order to capture and encode an image input from a camera, or to display video data, there are two methods: an interrupt method and a polling method.

The polling method will be described with reference to FIG. 1.

As shown in the timing diagram of FIGs. 1(A) and (B), a software unit for encoding (not shown) checks the state of a hardware unit (not shown) for camera capture and waits for a vertical synchronizing (Vsync) signal after encoding data of frames (see intervals 110 and 120 in FIG. 1(B)), and then, if the software unit receives the Vsync signal from the hardware unit, a capture command for data of frames 1 and 2 is transmitted. However, the state of the hardware unit should be continuously checked in the polling method, and thus overall speed is greatly decreased.

The interrupt method will be described with reference to FIGS. 2(A) (C). As shown in FIG. 2(A), a vertical synchronization signal generates an interrupt 220 immediately when a software unit requires data (see FIG. 2(B), stops routine operations of the software unit for a short time, and forcibly causes the software unit to transmit information required for capturing data of frame 1 to the hardware unit. When the interrupt is generated, the software unit performs an interrupt service routine (ISR).

Assuming that only two ping-pong memories are used, if the software unit receives an interrupt signal 220 while encoding frame 2 (see interval 210 of FIG. 2(C)), the software unit stops the encoding operation for a short time (see interval 212 of FIG. 2(C)), transmits information required for capturing data of frame 1 to the hardware unit, and then restarts encoding of frame 2. If another interrupt signal 221 is received even though the encoding operation of frame 2 is not completed, the software unit does not give a capture command for frame 2 but escapes from the ISR and performs encoding of frame 2 continuously.

Meanwhile, with respect to decoding, if the software unit receives an interrupt signal 220 while decoding frame 2 (see interval 210 of FIG. 2(C)), the software unit stops the decoding operation of frame 2 for a short time (see interval 212 of FIG. 2(C)), transmits information required for reading the data of frame 1 to the hardware unit, and then restarts decoding of frame 2. If another interrupt is received even though the decoding operation of frame 2 is not completed, the software unit does not give a read command for frame 2 but escapes from the ISR and performs decoding of frame 2 continuously.

Thus, in the interrupt method, if an interrupt is generated, encoding and decoding are immediately performed without waiting for a Vsync signal, and thus, the interrupt method is faster than the polling method.

However, if the interrupt is generated very often, pipelining cannot be used in a reduced instruction set computer (RISC) processor, and thus overall speed is decreased. In particular, although any one given type of interrupt for one particular purpose is not used frequently in a system, various types of interrupts are used together in the system. Various types of interrupts, for example, an interrupt for a camera, an interrupt for a LCD, an interrupt for a LAN, and an interrupt for a universal asynchronous receiver transmitter (UART) port, are used together in the system, and the camera and the LCD generate an interrupt every 33 ms. Thus, various types of interrupts are used together in a system using a conventional interrupt method, and thus, overall speed and stability in the system are decreased.

Also, in the conventional polling and interrupt methods, decoding time by software unit is not fixed, and thus, video data are processed unstably. That is, in a case where all available memory regions are used even though the decoding time of consecutive frames is so short that all image data are not displayed on a display device, video data decoded after that should be discarded. This causes consecutive video data to be moved suddenly, or resources of an encoder or decoder to be used unnecessarily.

### SUMMARY OF THE INVENTION

To solve the above problem, it is a first object of the present invention to provide a video pre-processing apparatus which is capable of stably operating at a high speed with a small amount of memory using a new hardware unit-software cooperation method, and a method used by the apparatus.

It is a second object of the present invention to provide a video post-processing apparatus which is capable of stably operating at a high speed with a small amount of memory using a new hardware unit-software cooperation method and, a method used by the apparatus.

Accordingly, to achieve the first object, according to one aspect of the present invention, there is provided a video pre-processing method for capturing video efficiently. The method includes the steps of (a) assigning numbers to a plurality of memory regions in order and circularly increasing the numbers in response to a frame synchronizing signal, (b) checking the storing memory regions in response to the frame synchronizing signal and capturing input video data, and (c) storing the captured video data in the memory regions in a predetermined order.

To achieve the first object, according to another aspect of the present invention, there is provided a video pre-processing apparatus for capturing video efficiently. The apparatus includes a memory unit divided into a plurality of regions each of which is assigned numbers, a software unit for generating a capture command in a memory region to be used at next time after a region used in the memory unit is checked whenever a video synchronizing signal is generated, and a hardware unit for circularly increasing the numbers of the regions of the memory unit in response to a frame synchronizing signal, capturing a received video signal in response to a capture command received from the software unit, and storing the video signal in the memory region in a predetermined order.

To achieve the second object, according to one aspect of the present invention, there is provided a video post-processing method for displaying video efficiently. The method includes the steps of (a) assigning numbers to a plurality of memory regions in order and circularly increasing the numbers in response to a frame synchronizing signal, (b) displaying the memory regions in response to a video synchronizing signal, checking the displayed memory regions, and storing video data in the memory regions in a predetermined order, and (c) sequentially displaying the video data stored in the memory region.

To achieve the second object, according to another aspect of the present invention, there is provided a video post-processing apparatus for displaying video efficiently. The apparatus includes a memory unit divided into a plurality of regions each of which are assigned numbers, a software unit for comparing the number of displayed memory regions in response to a video synchronizing signal with the number of decoded memory regions and generating a display command of video data, and a hardware unit for circularly increasing the numbers of the regions of the memory unit in response to a frame synchronizing signal and displaying a screen in a predetermined order of the memory unit in response to a display command generated in the software unit.

### BRIEF DESCRIPTION OF THE DRAWINGS

The above objects and advantages of the present invention will become more apparent by describing in detail preferred embodiments thereof with reference to the attached drawings in which:

FIGS. 1(A) and 1(B) are timing diagrams illustrating a conventional polling method for capturing/displaying video;

FIGS. 2(A), 2(B) and 2(C) are timing diagrams illustrating a conventional interrupt method for capturing/displaying video;

FIG. 3 is a block diagram illustrating an embodiment of a video preprocessing apparatus according to the present invention;

FIG. 4 illustrates the structure of a memory for capturing video data;

FIGS. 5(A), 5(B) and 5(C) are timing diagrams illustrating a video preprocessing method according to the present invention;

FIG. 6 is a flowchart illustrating the video pre-processing method according to the present invention;

FIG. 7 is a timing diagram of Y, U, and V data;

FIG. 8 is a timing diagram of video data which are input in units of frames;

FIG. 9 is a timing diagram illustrating control of the memory of FIG. 4;

FIG. 10 is a block diagram illustrating an embodiment of a video post-processing apparatus according to the present invention;

FIG. 11 illustrates the structure of a memory for displaying video data;

FIGS. 12(A), 12(B) and 12(C) are timing diagrams illustrating a video post-processing method according to the present invention;

FIG. 13 is a flowchart illustrating the video post-processing method according to the present invention; and

FIG. 14 is a timing diagram illustrating control of the memory of FIG. 11.

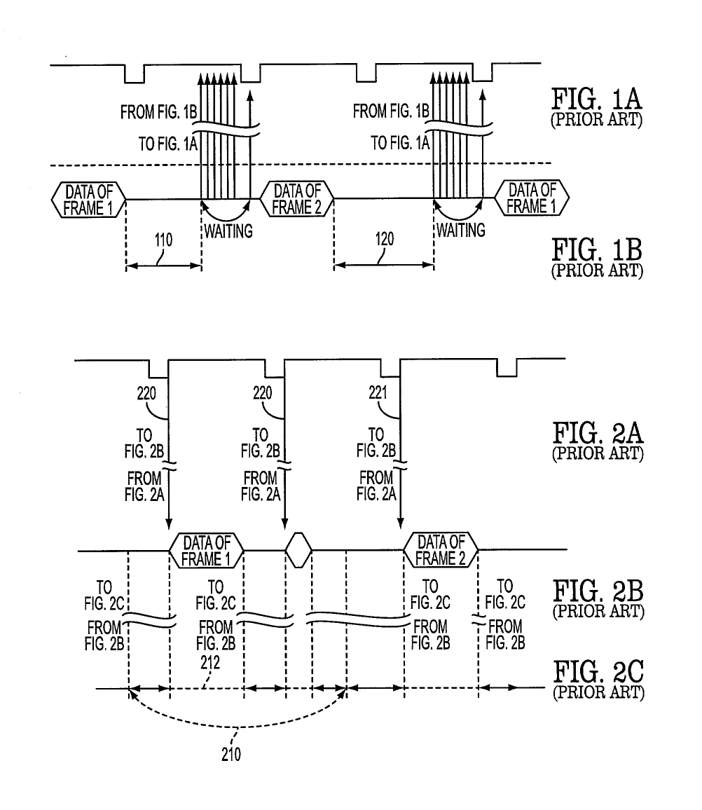

### DETAILED DESCRIPTION OF THE INVENTION

Hereinafter, preferred embodiments of the present invention will be described in detail with reference to the accompanying drawings.

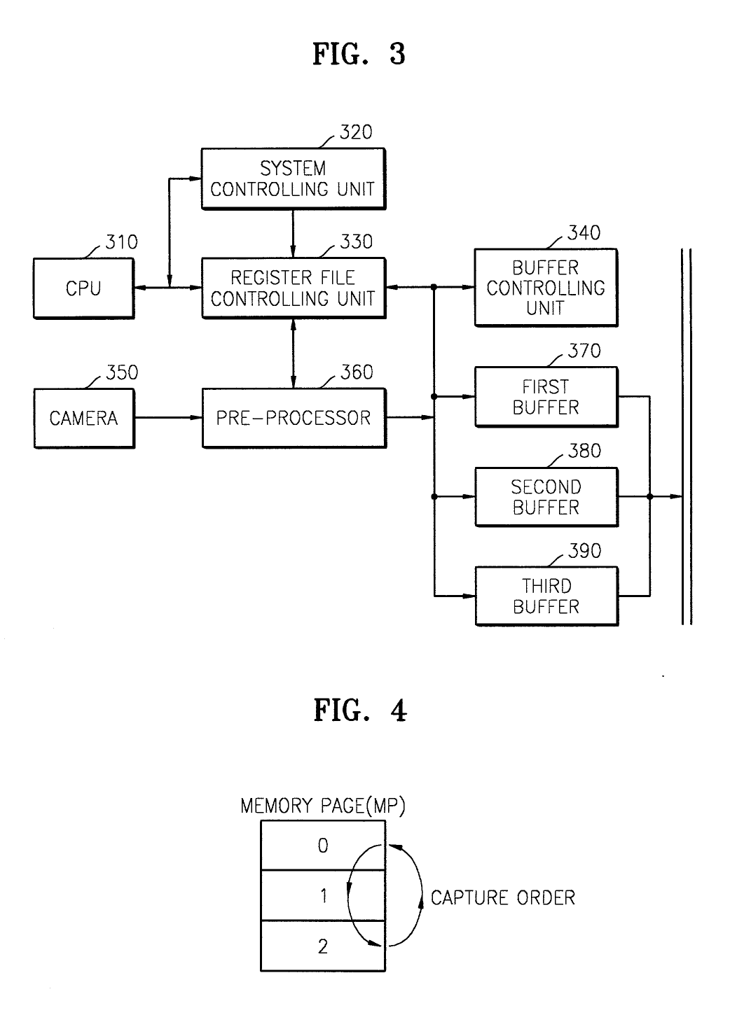

FIG. 3 is a block diagram illustrating an embodiment of a video preprocessing apparatus according to the present invention. Referring to FIG. 3, a central processing unit (CPU) 310 executes a software unit. The software unit controls the operation of a hardware unit (not shown) by a register file.

A system controlling unit 320 transmits a control command of the central processing unit (CPU) 310 to the hardware unit. If the CPU 310 writes operation data into a register file (not shown), the system controlling unit 320 interprets operation data, thereby performing a command of the software unit according to a predetermined protocol.

A register file controlling unit 330 controls the register file which is received from the CPU 310 in response to a control command of the system controlling unit 320 and the stipulated protocol. Also, the register file controlling unit 330 controls the register file according to a vertical synchronizing (Vsync) signal and interprets each bit of the register file.

A buffer controlling unit 340 buffers data, which are input at fixed times separated by a predetermined interval, in a buffer such as a synchronous dynamic random access memory (SDRAM).

A camera 350 outputs video data, vertical synchronizing (Vsync) and horizontal synchronizing (Hsync) signals to a pre-processor 360.

The pre-processor 360 converts input 4:2:2 video data into 4:2:0 video data. That is, the pre-processor 360 subsamples the video data in a vertical direction. First, second, and third buffers 370, 380, and 390 store a signal Y, a signal C_{b}, and a signal Cᵣ, respectively, which are input from the pre-processor 360. The buffer size can be varied according to the structure of a system.

FIG. 4 illustrates the structure of a memory for capturing video data.

Referring to FIG. 4, a hardware unit divides a memory into a plurality of memory pages during initializing, sets an address of each memory page and stores video in the memory page automatically according to a predetermined order if a capture command is received from a software unit. The memory pages are numbered 0 to 2 on the basis of a capture order, but the number may vary, for example, to accommodate parallel processing or specific applications.

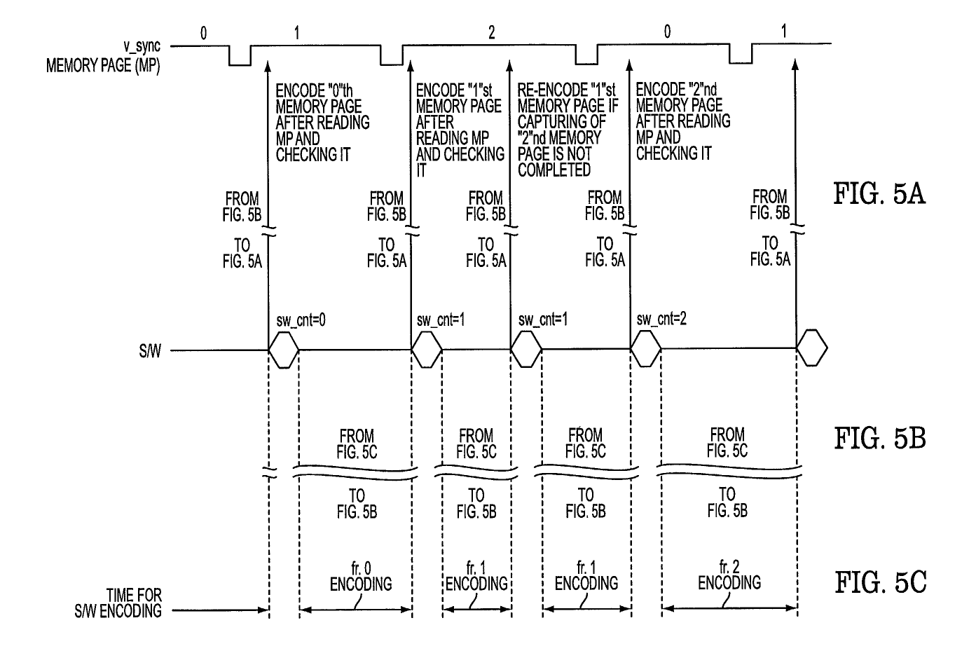

FIGS. 5(A)-(C) are timing diagrams illustrating a video preprocessing method according to the present invention. FIG. 5(A) is a timing diagram of a V_sync signal or a frame synchronizing signal that is generated from a hardware unit, and a memory page (MP) is increased in the order of “0 →1→2→0 . . . ” in response to the V_sync signal. The MP is a memory region in which the captured data are stored for a predetermined amount of time of one V_sync signal until a camera begins capturing and finishes capturing. The hardware unit operates as a slave of the software unit for memory control and checks via a register whether an image is captured.

FIG. 5(B) is a timing diagram illustrating control performed in a software unit, where the software unit reads a memory page and gives a capture command. Software count value sw_cnt represents a memory page to be encoded, is calculated by (MP+2) modulo 3 after the memory page is read in response to a V_sync signal, and is updated in the order of “0→1→1→2 . . . ”. Referring to the timing diagram of FIG. 5(b), the current memory page is read, and a capture command is given, and a “0”th memory page corresponding to (MP+2) modulo 3 is encoded if the memory page is checked as “1”st memory page (sw_cnt=0). Subsequently, the next memory page is read, and a capture command is given, and a “1”st memory page corresponding to (MP+2) modulo 3 is encoded if the memory page is checked as “2”nd memory page (sw_cnt =1). Subsequently, when the next memory page is read after the “1”st memory page is encoded, if capturing of the current memory page “2” is not completed, a previously captured frame is reused (sw_cnt=1). However, reusing the previously captured frame is a matter of design choice.

FIG. 5(C) is a timing diagram illustrating encoding performed by a software unit. The software unit controls a hardware unit to encode data stored in a memory page of (MP+2) modulo 3 in accordance with a calculated value of the software counter. If the memory page read by the software unit is being captured, an identical frame is re-encoded (fr. 1 encoding), and if not, the captured memory page is encoded (fr. 0 encoding and fr. 2 encoding).

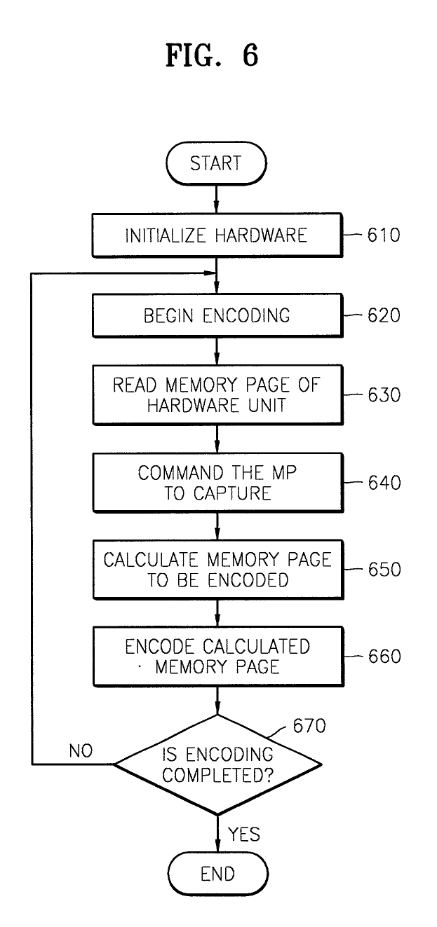

FIG. 6 is a flowchart illustrating the video pre-processing method according to the present invention and will be described with reference to FIGS. 3 and 4.

In step 610, a hardware unit of a system is initialized, and then, in step 620, the hardware unit begins encoding.

In step 630, a software unit reads a memory page (MP).

In step 640, the software unit checks the memory page (MP) and gives a capture command to the MP.

In step 650, the software unit calculates a memory page sw_cnt to be encoded by (MP+2) modulo 3.

In step 660, the software unit encodes the calculated memory page sw_cnt.

In step 670, it is determined whether encoding is completed, and if encoding is completed, pre-processing is ended. If not, the software unit performs pre-processing by reading the memory page again.

As another embodiment, in a case where parallel processing is performed in each step of encoding, the number or regions of a required memory is increased. For example, if the number to be parallel processed is Nₚ, the number of required memory pages (MP) is (Nₚ+2). In such a case, the number to be parallel processed is two each of ME/MC (motion estimation/motion compensation) and DCT (discrete cosine transform), and thus, four memory pages (MPs) are required, and a memory page to be encoded is (MP+3) modulo 4.

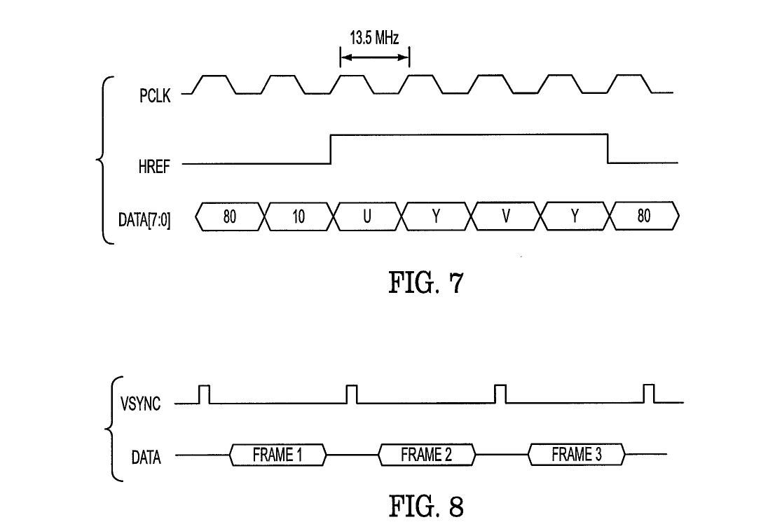

FIG. 7 is a timing diagram of input Y, U, and V data. Referring to FIG. 7, the CPU 310 supports encoding in units of frames. Thus, Y, C_{b}, and Cᵣ, which are input to a camera, support a capture function in units of frames.

The input video data are input in units of frames at each vertical synchronizing signal. As an embodiment of the present invention, the camera is a CCIR 601 format, and a QCIF (176×144) progressive scan method is applied to the camera. The input video data are 8-bit Y, U, and V data, and a clock signal PCLK of 13.5 MHz is input to the system, and 8-bit data DATA[7:0] are output in response to a synchronized clock signal.

FIG. 8 is a timing diagram of video data which are input in units of frames. Referring to FIG. 8, input video data DATA can be input at a maximum rate of 60 frames per second. Processing of the video data DATA depends on the capacity of an encoder. Thus, the hardware unit operates as a slave of the CPU 310 and selects an encoding frame. Since the frames of the input data are discriminated by an input vertical synchronizing signal VSYNC, the hardware unit selects data to be encoded in response to the VSYNC.

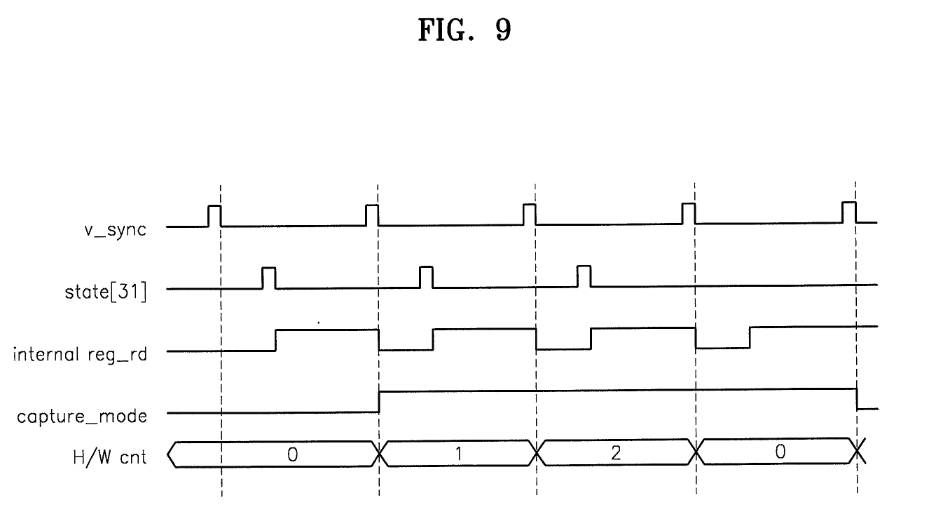

FIG. 9 is a timing diagram illustrating control of the memory of FIG. 4. Referring to FIG. 9, video data are input to a camera in response to vertical synchronizing signal v_sync and are captured as required by the CPU 310. The CPU 310 captures the video data through a register file. A capture command is transmitted to a register file by using a status register. Here, if a state bit “state[31]” is set to “1”, the video data are captured. Other set bits in the status register represent numbers 0, 1, and 2 of three memories which are being used in the hardware unit, as shown in FIG. 4. The CPU 310 reads the memory number and causes the sending of a memory region to be processed to the software unit.

More specifically, if a predetermined bit among state bits “state[31]” of the status register is set for the frame to be captured by the CPU 310, an internal register read signal “internal reg_rd” in the hardware unit is set to “1”. In such a case, if the vertical synchronizing signal v_sync is received, the internal register read signal internal reg_rd is changed to “0”. If the internal register read signal “internal reg_rd” is set to “0” and simultaneously capture bits are set in the status register, the video data are captured. Subsequently, if the capture bits are not set in the status register at the next vertical synchronizing signal v_sync, capture is enabled. As a result, the capture bits of the status register are checked at each vertical synchronizing signal v_sync. In a case where the data are captured in the hardware unit, the starting address of the set memory is stored in the CPU 310 after booting, and the value of the starting address is effective until the value of setting an address varies. The CPU 310 generates the starting address in units of the v_sync through a register. The number of memory regions H/W cnt is sequentially increased in the order of “0→1→2→0” if the data are captured for each v_sync.

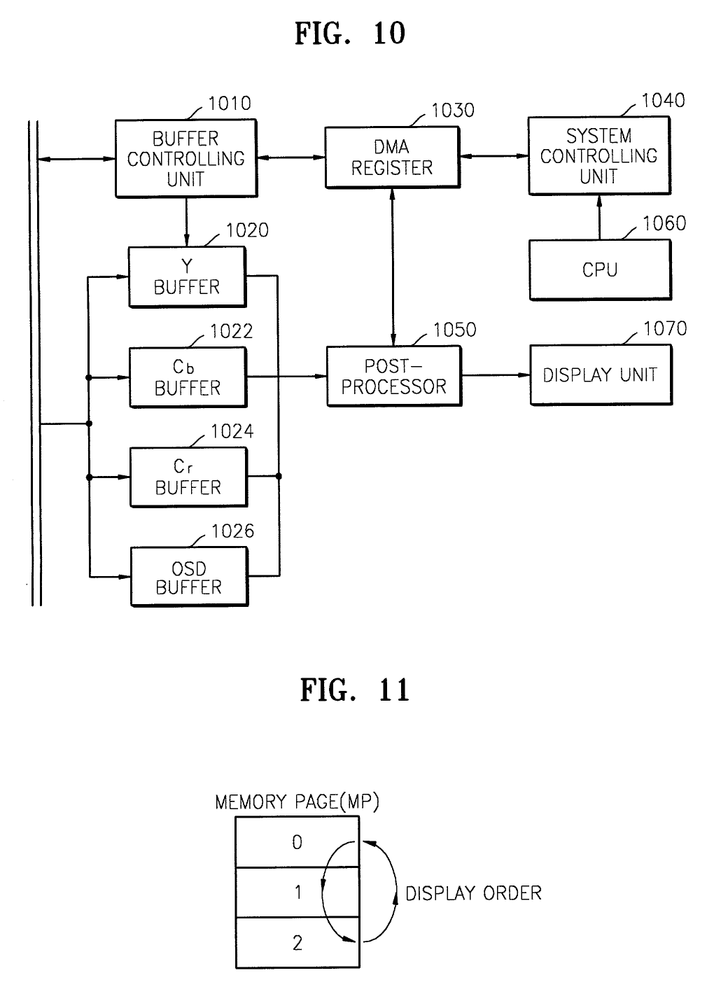

FIG. 10 is a block diagram illustrating an embodiment of a video post-processing apparatus according to the present invention. Referring to FIG. 10, data decoded in a source codec unit (not shown) are stored in a Y buffer 1020, a C_{b} buffer 1022, and a Cᵣ buffer 1024, in the order of Y, C_{b}, and Cᵣ, and are transmitted to a post-processor 1050 in response to vertical and horizontal synchronizing signals generated in a display unit 1070. The post-processor 1050 converts 4:2:0 data into 4:2:2 data, converts the 4:2:2 format of video data into the 4:4:4 format of RGB data and transmits the RGB data to the display unit 1070. Also, the post-processor 1050 accesses OSD data stored in an OSD buffer 1026, using a direct memory access (DMA) controller (not shown).

A system controlling unit 1040 transmits a control command of the central processing unit (CPU) 1060 to the hardware unit. If the CPU 1060 writes operation data into the register file and orders an operation for a hardware unit, the system controlling unit 1040 interprets the operation, thereby performing a command of the software unit according to each hardware unit and a predetermined protocol. The CPU 1060 transmits a display command through a register to control the hardware unit. A DMA register 1030 performs an operation according to data that are received from the register of the CPU 1060 in response to the control command of the system controlling unit 1040 and the predetermined protocol.

FIG. 11 illustrates the structure of a memory for displaying video data. Referring to FIG. 11, a hardware unit divides a memory page (MP) into a plurality of smaller memory pages during initialization, sets an address in each memory page and stores automatically displayed video according to a predetermined order if a display command is received from a software unit. The memory pages are numbered 0 to 2 on the basis of a capture order, but the number of pages may be greater depending, for example, on the requirements of parallel processing or of a specific application.

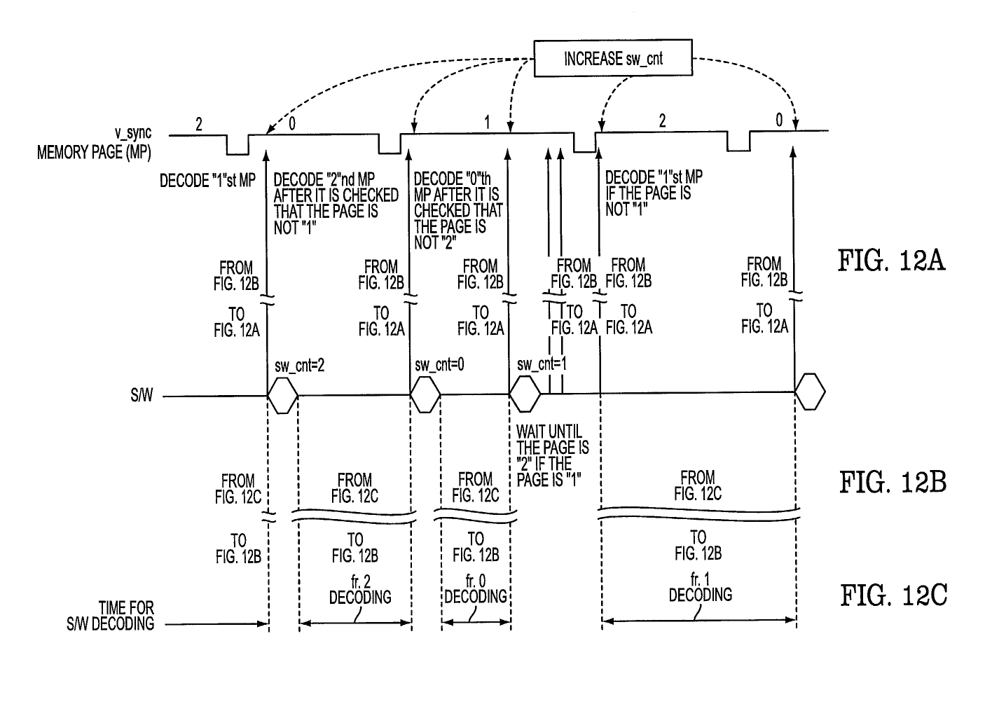

FIGS. 12(A) to 12(C) are timing diagrams illustrating a video post-processing method according to the present invention. FIG. 12(A) is a timing diagram of a vertical synchronizing signal V_sync or a frame synchronizing signal, which is generated from a hardware unit, a memory page (MP) is updated in the order of “2→0→1→2→0 . . . ” in response to the V_sync signal. The MP is a ping-pong memory region that is displayed for a predetermined amount of time equal to the period of the V_sync signal which is between when a liquid crystal display (LCD) begins displaying an image and finishes displaying the image. At this time, the hardware unit operates as a slave of the software unit for memory control and checks via a register whether an image is displayed.

FIG. 12(B) is a timing diagram illustrating control performed in the software unit, and the software unit reads the memory page displayed as shown in FIG. 12(A) and gives a display command. Software count value sw_cnt represents a memory page to be decoded and is increased in the order of “0→1→2→0 . . . ” after the displayed memory page is read in response to a vertical synchronizing signal V_sync. If the display command is not received, the last memory page is maintained. Referring to the timing diagram of FIG. 12(B), a displayed “0”th memory page is read, and then, it is checked whether the memory page is not the “1”st memory page, and if not, a “2”nd memory page is decoded (sw_cnt=2). Subsequently, a displayed “1”st memory page is read, and then, it is checked that the page is not the “2”nd memory page, and then, the “0”th memory page is decoded (sw_cnt=0). Subsequently, if the software unit reads the displayed memory page, but the memory page is still the “1”st memory page, the software unit waits until the page is the “2”nd memory page (sw_cnt=1). Subsequently, the software unit reads the displayed “2”nd memory page, and then, it is checked that the page is not the “1”st memory page, and the “1”st memory page is decoded (sw_cnt=1).

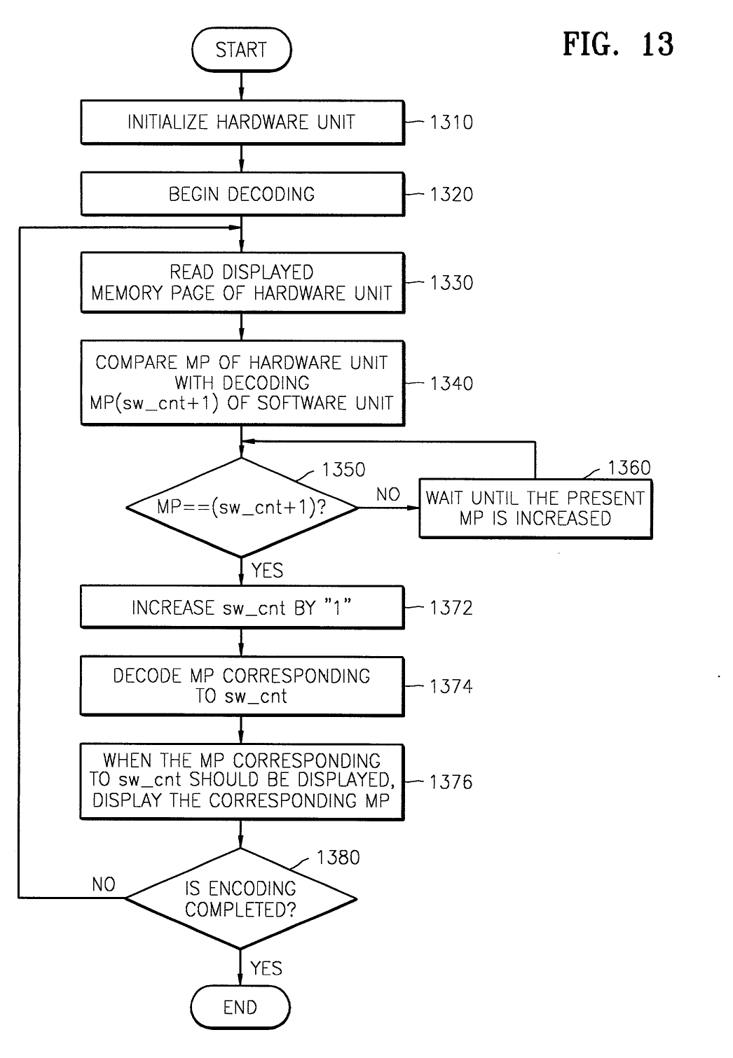

FIG. 12(C) is a timing diagram illustrating decoding performed by a software unit. The software unit controls a hardware unit to decode a memory page corresponding to the software count value sw_cnt. That is, if the software unit determines that the displayed memory page is the same as the memory page to be decoded, the software unit waits without decoding. If not, the software unit decodes the corresponding memory page (fr. 0, fr. 1, fr. 2 decoding). FIG. 13 is a flowchart illustrating the video post-processing method according to the present invention and will be described with reference to FIGS. 11 and 12.

In step 1310, a hardware unit of a system is initialized, and then, in step 1320, the hardware unit begins decoding.

In step 1330, a software unit reads a displayed memory page (MP) from the hardware unit.

In steps 1340 and 1350, the software unit compares the value of the displayed memory page (MN) with an increased software count value sw_cnt+1.

If the memory page (MP) is the same as the increased software count sw_cnt+1, in step 1360, the software unit waits without decoding until the displaying memory page (MP) is increased.

In step 1372, if the memory page (MP) is not the same as the increased software count value sw_cnt+1, the software count value sw_cnt is increased by “1”, and in step 1374, the memory page corresponding to the count value sw_cnt is decided.

In step 1376, when the memory page corresponding to the software count value sw_cnt should be displayed, the corresponding memory page is displayed. Data of the memory page are displayed for a predetermined amount of time of a synchronizing signal when at least two or more requests for display are made.

In step 1380, it is determined whether decoding is completed, and if decoding is completed, post-processing is ended. If not, the software unit performs post-processing by reading the memory page again.

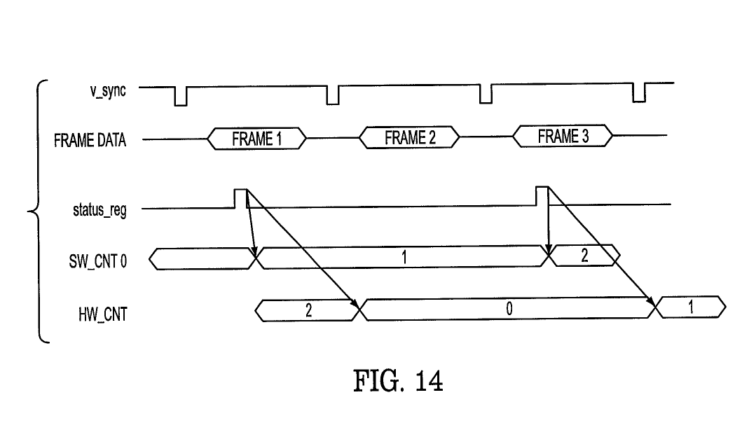

FIG. 14 is a timing diagram illustrating control of the memory of FIG. 11. Data read from a bus are stored in one of the (N) memory regions for post processing. A software unit selects a memory region in which decoded video data are to be stored. The CPU 1060 monitors the state of a memory that is being read. In a case where the software unit updates the data in the memory region that is being displayed, an image division phenomenon occurs.

Post-processing is performed in response to a vertical synchronizing signal (Vsync) as in pre-processing. Since there is no timing information in the software unit, the software unit selects the number (N) of memory regions when the data are stored in the memory the moment decoding is completed. The software unit reads the status register to determine a memory region and transmits information of the memory region to be displayed on the hardware unit via the register data. Predetermined bits among a status register are used as the register data. This means that the region of the displaying data is designated by number, and the number is transmitted to the CPU 1060. The number is effective if the next updating of data is not performed after the initial starting address of a number (N) of frames is set after booting. The CPU 1060 generates the starting address in units of vertical synchronizing signals (Vsync). A Y1 starting address, a Y2 starting address, and a Y3 starting address are mapped as 0, 1, and 2 in the memory region of FIG. 11.

As shown in FIG. 14, the CPU 1060 counts two values corresponding to a software count value sw_cnt, and a hardware count value hw_cnt using two bits of a status register status reg. If decoding is completed, the software unit reads the hardware count value hw_cnt. Here, the software unit transmits numbers, which are not used in the hardware count value hw_cnt, to the hardware unit sequentially. The hardware unit increases the numbers linearly and transmits the numbers to the software unit. If the hardware unit cannot receive a count value from the software unit, data are read from the previous address, thereby causing an image holding phenomenon. If a redundant buffer is added, the software unit can decode two frames within an interval between vertical synchronizing signals (Vsync). First, a difference between the software count value sw_cnt and the hardware unit count value hw_cnt is maintained at two. Here, if two frames are decoded in a Vsync interval, a difference between two count values is decreased by one.

There is a number (N_{b}) of memory pages for a buffer in the present invention, and time required for decoding is delayed by one frame whenever the memory page for a buffer is increased by one. However, in a case where the software unit waits until the number of the memory page is increased as shown in FIG. 12 (B) (sw_cnt=1), a frame buffer is generated when a vertical synchronizing signal (V_sync) is generated, and thus, waiting time for decoding is decreased. If display exceeding a number (1+N_{b}) of memory pages is requested via a V_sync signal, the software unit waits until an unrequested V_sync is generated. For example, if a number (N_{b}) of redundant buffers are generated, a total number (N_{b}+3) of memory pages are generated. Here, N_{b} should be stipulated between a decoder and a display device. Three memory pages are included in FIG. 11, but the number of the memory pages may be increased according to the number of buffers.

From a decoding aspect, display of a maximum number (1+N_{b}) of memory pages can be requested within a V_sync period. If the number (N_{b}) of memory pages (MPs) for a buffer is in a full state, only one display may be requested for a predetermined amount of time of a V_sync period. If the decoder cannot immediately request a driving unit to display memory pages, decoding is delayed until the request is possible. The state of all driving units for display is determined by the memory page of the hardware unit.

As described above, since the present invention operates without the waiting or interruptions of the conventional polling and interrupt methods, fast speed and stable operation are possible. Further, a captured screen is always provided by request of a video encoder, and thus the screen appears naturally to the naked eye. Further, since only a capture command is given after most information related to capture are set during initialization, control can be simply performed.

Since there are few frames lost due to memory restrictions while a displayed screen is always provided at the request of a video decoder, the display on the screen appears natural to the eye. Further, since only a display command is given after most information related to display are set during initialization, control can be simply performed, and a maximum 30 pages per second of display can be performed by a memory page for a buffer without delay of decoding processing.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A video pre-processing method for capturing video efficiently, the method comprising the steps of:
(a) assigning numbers to a plurality of memory regions in order and circularly increasing the numbers in response to a frame synchronizing signal;
(b) checking the memory regions in response to the frame synchronizing signal and capturing input video data; and
(c) storing the captured video data in the memory regions in a predetermined order.

2. The video pre-processing method claimed in claim 1, wherein the video data are captured in predetermined units.

3. The video pre-processing method claimed in claim 1, wherein the video data are captured by a capture command which is received in units of synchronization of a frame or in units of synchronization of several frames through a register.

4. The video pre-processing method claimed in claim 1, wherein the video data is captured, stored in a predetermined region of a memory and the region of a stored memory is transmitted in step (c).

5. The video pre-processing method claimed in claim 1, wherein the starting address of the memory region for storing the captured data is an address of a memory region stored after booting a computer which controls the pre-processing method.

6. The video pre-processing method claimed in claim 5, wherein the starting address of the memory is effective until an address update is permitted.

7. The video pre-processing method claimed in claim 5, wherein the starting address of the memory is determined in units of synchronization of a frame or in units of synchronization of several frames.

8. The video pre-processing method claimed in claim 1, wherein the memory region in which data are stored is divided into a plurality of regions, and addresses corresponding to the respective plurality of regions are set.

9. A video pre-processing method comprising the steps of:
(a) numbering a plurality of memory regions in order;
(b) circularly checking the number of the memory regions in response to a frame synchronizing signal, generating a capture command in the memory regions, and calculating a memory region to be encoded; and
(c) encoding data of the calculated memory region.

10. The video pre-processing method claimed in claim 9, wherein the previous frame is re-encoded if the memory region checked after encoding is completed is the same as the memory region to be encoded.

11. The video pre-processing method claimed in claim 9, wherein the memory region to be encoded is calculated by (MP+k) modulo N, where MP is memory page, k=N−1, and N is the number of the region.

12. The video pre-processing method claimed in claim 9, wherein the number of a memory page is (Nₚ+2) and the memory region to be encoded according to the number of the memory page is calculated by (MP+k) modulo N, where k=N−1, and N is the number of the region if a memory required for parallel capture processing is Nₚ.

13. A video pre-processing apparatus for capturing video efficiently, the apparatus comprising:
a memory unit divided into a plurality of regions each of which is assigned a respective region number;
a software unit for generating a capture command in a memory region to be used a next time after a region used in the memory unit is checked whenever a video synchronizing signal is generated; and
a hardware unit for circularly increasing the region number of the memory unit in response to a frame synchronizing signal, capturing a received video signal in response to a capture command received from the software unit, and storing the video signal in the memory region in a predetermined order.

14. The video pre-processing apparatus claimed in claim 13, wherein the software unit is a means for setting a capture command in a register file.

15. A video post-processing method for displaying video efficiently, the method comprising the steps of:
(a) assigning numbers to a plurality of memory regions in order and circularly increasing the numbers in response to a frame synchronizing signal;
(b) displaying images stored in the memory regions in response to a video synchronizing signal, checking the displayed images, and storing video data in the memory regions in a predetermined order; and
(c) sequentially displaying the video data stored in the memory regions.

16. The video post-processing method claimed in claim 15, wherein the video data are displayed in predetermined units.

17. The video post-processing method claimed in claim 15, wherein the video data are displayed by a display command that is received in units of synchronization of a frame.

18. The video post-processing method claimed in claim 15, further comprising the step of transmitting the number of the memory region corresponding to the displayed video data after the video data are displayed.

19. The video post-processing method claimed in claim 15, wherein initial starting addresses of the memory regions to be displayed are set after booting a computer which controls the post-processing method.

20. The video post-processing method claimed in claim 19, wherein the initial starting addresses of the memory regions are effective until an address update is permitted.

21. The video post-processing method claimed in claim 19, wherein the initial starting addresses of the memory regions are determined in units of synchronization of a frame.

22. The video post-processing method claimed in claim 15, wherein the memory regions in which data are stored are divided into a plurality of sub-regions, and addresses corresponding to the respective plurality of sub-regions are set.

23. A video post-processing method comprising the steps of:
(a) numbering a plurality of memory regions in an order of display;
(b) addressing, in the order of display, respective decoding memory regions as memory regions to be decoded after respective displaying memory regions are read in response to a frame synchronizing signal; and
(c) decoding the respective decoding memory regions and displaying the respective decoded memory regions.

24. The video post-processing method claimed in claim 23, wherein a next screen is displayed if a current respective decoding memory region is different from a current displayed respective decoded memory region.

25. The video post-processing method claimed in claim 24, wherein the next screen is displayed when at least two requests for display are made in a predetermined period of a synchronizing signal.

26. The video post-processing method claimed in claim 25, wherein requests for display of a number (1+N) of memory regions are made in the predetermined period of a synchronizing signal, where N is the number of the plurality of memory regions.

27. The video post-processing method claimed in claim 25, wherein display of the next screen is not performed until an unrequested synchronizing signal is input when a number of requests, exceeding a number (1+N), for display of memory regions are made in the predetermined period of a synchronizing signal, where N is the number of the plurality of memory regions.

28. The video post-processing method claimed in claim 26, wherein display of the next screen is not performed until an unrequested synchronizing signal is input when a number of requests, exceeding a number (1+N), for display of memory regions are made in the predetermined period of a synchronizing signal.

29. The video post-processing method claimed in claim 23, wherein the decoding is not performed if a current respective decoding memory region is the same as a current displayed respective decoded memory region.

30. A video post-processing apparatus for displaying video efficiently, the apparatus comprising:
a memory unit divided into a plurality of regions each of which is assigned a number;
a software unit for comparing a number of a respective displayed memory region in response to a video synchronizing signal with a number of a respective decoded memory region and generating a display command of video data; and
a hardware unit for addressing, cyclically by assigned number, the regions of the memory unit in response to a frame synchronizing signal and successively displaying screens of the addressed memory regions in a predetermined order in response to the display command generated in the software unit.

31. The apparatus as claimed in claim 30, wherein the software unit is a means for setting a display command in a register.
